(19) United States
(12) Patent Application Publication
(10) Pub. No.: US 2013/0088955 A1
(43) Pub. Date: Apr. 11, 2013

(54) Method and System for Distributed, Prioritized Bandwidth Allocation in Networks

(71) Applicant: Telcordia Technologies, Inc., Piscataway, NJ (US)

(72) Inventors: Eric van den Berg, Hoboken, NJ (US); Stuart Wagner, Milford, NJ (US); Gi Tae Kim, Millburn, NJ (US)

(73) Assignee: TELCORDIA TECHNOLOGIES, INC., Piscataway, NJ (US)

(21) Appl. No.: 13/644,846

(22) Filed: Oct. 4, 2012

Related U.S. Application Data
(60) Provisional application No. 61/543,578, filed on Oct. 5, 2011.

(51) Int. Cl. H04L 12/56

(52) U.S. Cl. CPC H04L 47/2433
USPC 370/230

(57) ABSTRACT

An apparatus, system and method are introduced for prioritizing allocation of communication bandwidth in a network. In one embodiment, the apparatus includes memory including computer program code configured to, with a processor, cause the apparatus to assign a value to a prioritization parameter at an endpoint communication device dependent on a priority of an information flow in a network, and update a communication bandwidth for the information flow dependent on the value of the prioritization parameter after a round-trip time for the information flow.

This application claims the benefit of U.S. Provisional Application No. 61/543,578, entitled “Method and System for Distributed, Prioritized Bandwidth Allocation in IP Networks,” filed on Oct. 5, 2011, which is incorporated herein by reference.

### TECHNICAL FIELD

The present invention is directed, in general, to communication systems and, more specifically, to a system and method for prioritizing allocation of communication bandwidth in a network.

### BACKGROUND

There have been numerous attempts to solve the problem of prioritizing bandwidth allocations in communication network such as Internet protocol (“IP”) networks. A “bandwidth broker” approach to prioritizing bandwidth allocations utilizes a centralized management mechanism to sense the state of a network, including available bandwidth on network links and paths. Hosts that want to send information through the network send requests to the centralized bandwidth broker indicating for instance, information flow priority, source and destination hosts, and desired bandwidth. The broker then algorithmically determines the appropriate allocation of bandwidth to the information flow or traffic to a requesting host, based on the broker's knowledge of network state, the presence and relative priorities of competing information flows, and the data provided by the requesting host concerning a new information flow.

Distributed approaches to bandwidth allocation also have been proposed, and utilize protocols such as the resource reservation protocol (“RSVP”), a transport layer protocol that enables a receiver (or user equipment) to periodically reserve simplex network resources for an integrated-services Internet, and the Telecommunications Industry Association (“TIA”)-1039 standard. In these cases, a host wishing to send an information flow through the network first transmits control-plane message packets along the intended path of the information flow. The messages can contain information concerning information flow priority, desired bandwidth, and/or other service attributes. Routers along the path intercept and process these messages in a manner that enables the requesting host to verify that the desired bandwidth has been reserved by the network. Bandwidth brokers and RSVP/TIA-1039 protocols are both “out of band” allocation techniques in the sense that the techniques employ signaling that is separate from the information flow that the requesting host wants to send.

Differentiated services (“DiffServ”) is an in-band form of bandwidth allocation that separates information flows into service classes. It is a quality of service (“QoS”) protocol for managing bandwidth allocation for Internet media connections (e.g., for a voice over Internet (“VOIP”) voice connection). Each packet within each information flow is marked with a “DiffSery code point” (“DSCP”) indicating a class. Routers along the path of the information flow sort and queue received packets according to the DSCPs. Each router interface allocates a percentage of the bandwidth to each of the service classes. The allocations are determined through network management and are quasi-static.

Another in-band form of bandwidth allocation is the information flow control and congestion feedback mechanisms inherent in a transmission control protocol (“TCP”). Using congestion feedback, all information flows traversing a particular network bottleneck sense the presence of congestion (or in other words, the limited bandwidth of the bottleneck) and respond by reducing their transmission rates such that in equilibrium the information flows collectively consume the bottleneck bandwidth that is available thereto, with each information flow receiving approximately the same amount of the available bandwidth.

The prior solutions have suffered significant limitations with respect to an ability to prioritize bandwidth allocation in a useful manner Reliance on bandwidth brokers can result in significant control-plane signaling overhead. Not only does each host have to signal the bandwidth broker to obtain an allocation, but the broker relies on probes or other techniques to sense and remain up-to-date on the availability of routes and bandwidths throughout the network. Moreover, if the broker becomes unreachable due to, for instance, connectivity problems within wireless networks (a common limitation in military environments), hosts will not be able to obtain allocations. The RSVP and TIA-1039 protocols also can employ significant signaling overheads and are not compatible with encryption boundaries such as Internet protocol security (“IPSec”) gateways and military high assurance Internet protocol encryptor (“HAIPE”) devices.

The IPSec is a protocol suite for securing Internet protocol communications by authenticating and encrypting each Internet protocol packet of a communication session. The HATE device is an encryption device that complies with the National Security Agency's high assurance Internet protocol interoperability specification. In addition, for information flows to receive the requested treatments across complete network paths, all routers should be compatible with the respective protocols. In other words, the routers should contain the software necessary to intercept and process the RSVP or TIA-1039 messages. Not all routers will have these capabilities.

DiffSery is a more common capability in routers, but suffers from two other major problems. First, DiffSery is inappropriate as a prioritization mechanism, because DSCPs pass through the network unprotected and unencrypted. As a result, adversaries within the network can modify DSCPs and/or glean considerable intelligence by observing which hosts are generating the highest-priority traffic. Second, DiffSery allocates bandwidth in a relatively static manner that offers no bandwidth guarantees and does not adequately respond to changes in network state (e.g., link failures). This lack of dynamic adaptation could easily result in high-priority information flows receiving far smaller bandwidths than the initial network configuration anticipated.

Limitations of these prioritization approaches have now become substantial hindrances for communication across bandwidth-limited Internet networks, and no satisfactory strategy has emerged to provide improved allocation of communication priorities to information flows simultaneously competing for common bandwidths. Accordingly, what is needed in the art is a new approach that overcomes the deficiencies in the current solutions.

### SUMMARY OF THE INVENTION

These and other problems are generally solved or circumvented, and technical advantages are generally achieved, by advantageous embodiments of the present invention, in which an apparatus, system and method are introduced for prioritizing allocation of communication bandwidth in a network. In one embodiment, the apparatus includes memory including computer program code configured to, with a processor, cause the apparatus to assign a value to a prioritization parameter at an endpoint communication device dependent on a priority of an information flow in a network, and update a communication bandwidth for the information flow dependent on the value of the prioritization parameter after a round-trip time for the information flow.

The foregoing has outlined rather broadly the features and technical advantages of the present invention in order that the detailed description of the invention that follows may be better understood. Additional features and advantages of the invention will be described hereinafter, which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, reference is now made to the following descriptions taken in conjunction with the accompanying drawings, in which:

FIG. 1 illustrates a system level diagram of an embodiment of a communication system;

FIG. 2 illustrates a block drawing of an embodiment of a self-adaptation module;

FIGS. 3 to 5 illustrate graphical representations of exemplary simulation results demonstrating throughputs from sources in a network; and

FIG. 6 illustrates a flow diagram of an embodiment of a method of prioritizing bandwidth allocations for an information flow in a network.

Corresponding numerals and symbols in the different figures generally refer to corresponding parts unless otherwise indicated, and may not be redescribed in the interest of brevity after the first instance. The FIGURES are drawn to illustrate the relevant aspects of exemplary embodiments.

### DETAILED DESCRIPTION OF ILLUSTRATIVE EMBODIMENTS

The making and usage of the present exemplary embodiments are discussed in detail below. It should be appreciated, however, that the embodiments provide many applicable inventive concepts that can be embodied in a wide variety of specific contexts. The specific embodiments discussed are merely illustrative of specific ways to make and use the systems, subsystems and modules associated with a process for prioritizing bandwidth allocations for information flows through a bandwidth limitation in a network such as an IP network.

A process to allow prioritization of bandwidth allocations among a plurality of competing information flows that may pass through a network hop with a shared bandwidth limitation will be described. The process will be described in a specific context, namely, modifications to the TCP. (For a discussion on TCP, see “A duality model of TCP and queue management algorithms,” by S. Low, IEEE/JACM Transactions on Networking, vol. 11, pp. 525-5365, August 2003, which is incorporated herein by reference.) While the principles will be described in an environment of communicating messages/data over the Internet, any environment that may benefit from a process for prioritization of bandwidth allocations that enables adjustment of information flows through a shared bandwidth limitation is well within the broad scope of the present disclosure.

A distributed and scalable process is introduced to address the problem of prioritizing allocation of a limited network bandwidth (i.e., a “bandwidth bottleneck”) to multiple competing information flows traversing the bottlenecks. This problem is well-known in the art and is important in a wide variety of networking applications, such as cloud computing, voice over IP (“VoIP”), multimedia communication, file transfers and messaging. The process prioritizes bandwidth allocations via modifications to TCP operation, including the use of information flow-specific, application-specific, and/or user-specific information flow-control parameters that self-adapt to suit network conditions and allocation policies.

The process of prioritizing allocation of shared, limited, network bandwidth differs from the conventional solution in several ways. In one way, bandwidth allocation is fully distributed and adaptive. No bandwidth brokers or other centralized allocation mechanisms are needed. (For a discussion of bandwidth brokers, see “On scalable design of bandwidth brokers,” by Z. Zhang, et al., IEICE Trans. Comm., pp. 2011-2025, August 2001, and “Managing data transfers in computer clusters with Orchestra,” M. Choudhury, et al., Proc. 2011 SIGCOMM, August 2011, which are incorporated herein by reference.) No explicit allocations are necessary in advance of information flows, which differentiates this approach from DiffServ. (For a discussion on DiffServ, see “An Architecture for Differentiated Service,” S. Blake, et al., RFC 2475, December 1998, which is incorporated herein by reference.) It is differentiated from the present form of TCP which does not employ information flow-specific rate parameters for prioritization or the use of self-adaptive rate parameters.

In a second way, signaling for prioritized bandwidth allocation is implicit and does not require separate signaling messages, either in-band or out-of-band. In this respect, the present solution differs from RSVP (see “Resource Reservation Protocol (RSVP),” R. Braden, et al., RFC 2205, September 1997, which is incorporated herein by reference) and TIA-1039 (see “QoS Signaling for IP QoS Support,” TIA Standard TIA-1039, May 2006, which is incorporated herein by reference) and, as a result, the solution is compatible with red/black boundaries, while the other approaches are not. In cryptographic systems, sensitive or classified plaintext information is generally referred to as “red” signals, which are differentiated from encrypted information (“ciphertext”), referred to as “black” signals. In the present solution, prioritization information may be provided by endpoint communication devices and is not indicated explicitly in packets or information flows, making the approach more secure than DiffServ.

The process is described with focus, without limitation, on a specific version of TCP known as “Vegas,” which is known to provide throughput and fairness properties compared with other TCP algorithms. (For a discussion on “Vegas,” see “Understanding TCP Vegas: a duality model,” by S. Low, et al., Journal of ACM, vol. 49, pp. 207-235, March 2002, and, “TCP Vegas: End to end congestion avoidance on a global Internet,” by L. Brakmo, et al., IEEE Journal on Selected Areas in Communication, vol. 13, pp. 1465-1480, October 1995, which are incorporated herein by reference.) For a host “s” originating an information flow, the Vegas algorithm updates a communication bandwidth in the form of a TCP congestion window wₛ(t) once per packet round-trip time according to the difference equation:

$${w}_{s} ( t + 1 ) = \{ \begin{matrix}{w}_{s} ( t ) + \frac{1}{{D}_{s} ( t )} & if {w}_{s} ( t ) - {d}_{s} {x}_{s} ( t ) < {α}_{s} {d}_{s} \\ {w}_{s} ( t ) - \frac{1}{{D}_{s} ( t )} & if {w}_{s} ( t ) - {d}_{s} {x}_{s} ( t ) > {α}_{s} {d}_{s} \\ {w}_{s} ( t ) & otherwise ,\end{matrix}$$

wherein Dₛ(t) is the total round-trip delay at time t, dₛ is the propagation delay component of Dₛ(t), x₂(t) is the host's transmission rate at time t, and αₛ is a prioritization parameter for the host “s.” The Vegas algorithm also has a βₛ parameter, and the parameter βₛ is set to βₛ=αₛ in this embodiment. Thus, the congestion window wₛ(t) for a host “s” originating an information flow is continually incremented or decremented when its congestion window minus a product of its propagation delay times and transmission rate is less than or exceeds a prioritization parameter multiplied by its propagation delay. The product of the propagation delay times the transmission rate is a measure of an amount of data transmitted by the source that is in transit in the network (i.e., data that has been transmitted but not yet received). In practical implementations of TCP Vegas, the window w(t) is updated once per round-trip time, and Vegas achieves an equilibrium rate proportional to the parameter α=αₛdₛ.

Previous research has shown that the utility function for TCP Vegas as commonly implemented in a host operating system is:

U_{vegas}(xₛ)−α·log(xₓ),

wherein the prioritization parameter α is a same, fixed constant for all hosts in a standard TCP Vegas implementation. Moreover, the TCP Vegas algorithm solves the following maximization measure:

max Σₛα·log (xₛ)

An aspect for prioritizing bandwidth allocations among a plurality of simultaneously competing information flows is to allow assignment of different values of the prioritization parameter α dependent on information flow priority at, for instance, an endpoint communication device to different information flows. By assigning different values to different information flows, information flows assigned a higher value of the prioritization parameter α will achieve a proportionally larger equilibrium rate compared with information flows with lower value of the prioritization parameter α; hence, the former will attain higher throughputs than the latter. This approach allows utilization of prioritization parameters α as a mechanism for prioritizing bandwidth allocation because the higher-priority information flows will receive a proportionally larger share of the bottleneck bandwidth. This property of TCP Vegas is also called the “proportional fairness property.”

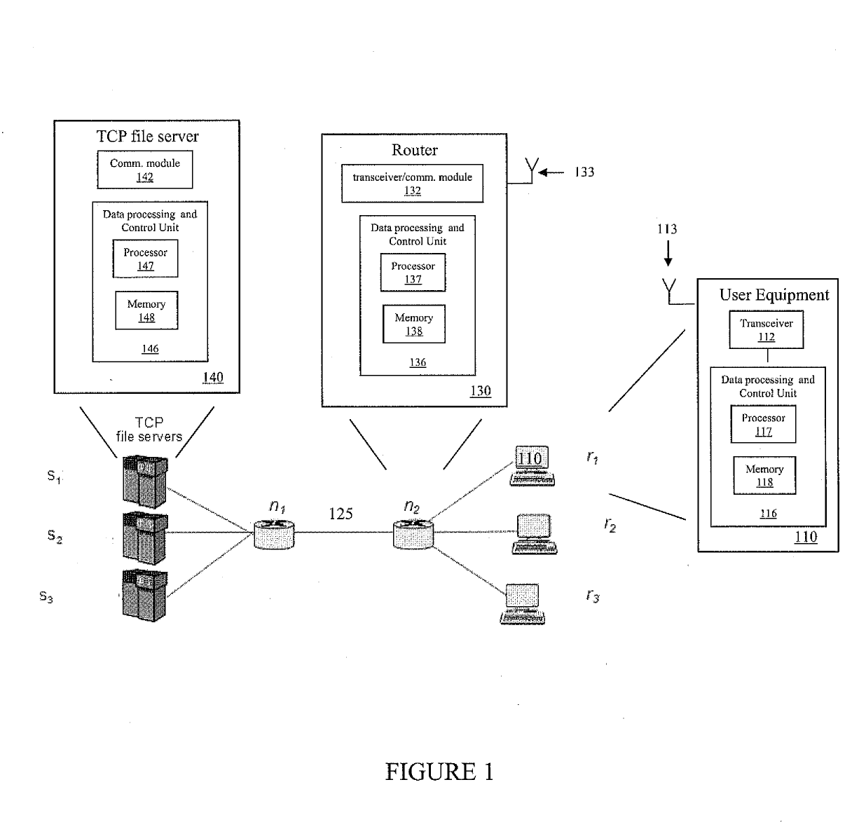

Turning now to FIG. 1, illustrated is a system level diagram of an embodiment of a communication system. The communication system illustrates TCP file servers s₁, s₂, s₃ that are independent information sources in an IP network. The TCP file servers s₁, s₂, s₃ communicate with corresponding remote receivers r₁, r₂, r₃ through a shared and limited IP bandwidth. Each TCP file server s₁, s₂, s₃ has a respective prioritization parameter α₁, α₂, α₃ and communicates remotely with the corresponding receiver r₁, r₂, r₃. In this example, the prioritization parameters α₁, α₂, α₃ exhibit the relationship α₃>α₂>α₁, indicating a higher communication priority of TCP file server s₃ over TCP file server s₂, etc. with their corresponding receivers r₂, r₃. The communication paths between the TCP file servers s₁, s₂, s₃ and their corresponding receivers r₁, r₂, r₃ share a common Internet bottleneck link 125 (a bandwidth-limited hop) with limited bandwidth between a first router n₁ and a second router n₂.

The communication system may form a portion of an IP network and includes the receivers r₁, r₂, r₃, which communicate wirelessly and bidirectionally with the second router n₂. The receivers r₁, r₂, r₃ may each be equipped with a TCP communication process. The first router n₁ is coupled to the TCP file servers s₁, s₂, s₃. The TCP file servers s₁, s₂, s₃ are each equipped with a TCP internetworking control component.

The receivers r₁, r₂, r₃ generally represented as user equipment 110 are formed with a transceiver 112 coupled to one or more antennas 113. The user equipment 110 includes a data processing and control unit 116 formed with a processor 117 coupled to a memory 118. Of course, the user equipment 110 can include other elements such as a keypad, a display, interface devices, etc. The user equipment 110 is generally, without limitation, a self-contained (wireless) communication device intended to be operated by an end user (e.g., subscriber stations, terminals, mobile stations, machines, or the like). Of course, other user equipment 110 such as a personal computer may be employed as well.

The second router n₂ (also designated 130) is formed with a transceiver/communication module 132 coupled to one or more antennas 133 and an interface device. Also, the transceiver/communication module 132 is configured for wireless and wired communication. The second router n₂ may provide point-to-point and/or point-to-multipoint communication services: The second router n₂ includes a data processing and control unit 136 formed with a processor 137 coupled to a memory 138. Of course, the second router n₂ may include other elements such as a telephone modem, etc. The second router n₂ is equipped with a TCP internetworking control component.

The second router n₂ may host functions such as radio resource management. For instance, the second router n₂ may perform functions such as Internet protocol (“IP”) header compression and encryption of user data streams, ciphering of user data streams, radio bearer control, radio admission control, connection mobility control, dynamic allocation of communication resources to an end user via user equipment 110 in both the uplink and the downlink, and measurement and reporting configuration for mobility and scheduling. Of course, the first router n₁ may include like subsystems and modules therein.

The TCP file server s₁ (also designated 140) is formed with a communication module 142. The TCP file server s₁ includes a data processing and control unit 146 formed with a processor 147 coupled to a memory 148. Of course, the TCP file server sᵢ includes other elements such as interface devices, etc. The TCP file server s₁ generally provides access to a telecommunication network such as a public service telecommunications network (“PSTN”). Access may be provided using fiber optic, coaxial, twisted pair, microwave communications, or similar link coupled to an appropriate link-terminating element. The TCP file server s₁ is equipped with a TCP internetworking control component. Of course, the other TCP file servers s₂, s₃ may include like subsystems and modules therein.

The transceivers modulate information onto a carrier waveform for transmission by the respective communication element via the respective antenna(s) to another communication element. The respective transceiver demodulates information received via the antenna(s) for further processing by other communication elements. The transceiver is capable of supporting duplex operation for the respective communication element. The communication modules further facilitate the bidirectional transfer of information between communication elements.

The data processing and control units identified herein provide digital processing functions for controlling various operations required by the respective unit in which it operates, such as radio and data processing operations to conduct bidirectional wireless communications between radio network controllers and a respective user equipment coupled to the respective base station. The processors in the data processing and control units are each coupled to memory that stores programs and data of a temporary or more permanent nature.

The processors in the data processing and control units, which may be implemented with one or a plurality of processing devices, performs functions associated with its operation including, without limitation, precoding of antenna gain/phase parameters, encoding and decoding of individual bits forming a communication message, formatting of information and overall control of a respective communication element Exemplary functions related to management of communication resources include, without limitation, hardware installation, traffic management, performance data analysis, configuration management, security, and the like. The processors in the data processing and control units may be of any type suitable to the local application environment, and may include one or more of general-purpose computers, special purpose computers, microprocessors, digital signal processors (“DSPs”), field-programmable gate arrays (“FPGAs”), application-specific integrated circuits (“ASICs”), and processors based on a multi-core processor architecture, as non-limiting examples.

The memories in the data processing and control units may be one or more memories and of any type suitable to the local application environment, and may be implemented using any suitable volatile or nonvolatile data storage technology such as a semiconductor-based memory device, a magnetic memory device and system, an optical memory device and system, fixed memory and removable memory. The programs stored in the memories may include program instructions or computer program code that, when executed by an associated processor, enable the respective communication element to perform its intended tasks. Of course, the memories may form a data buffer for data transmitted to and from the same. In the case of the user equipment, the memories may store applications (e.g., virus scan, browser and games) for use by the same. Exemplary embodiments of the system, subsystems, and modules as described herein may be implemented, at least in part, by computer software executable by processors of the data processing and control units, or by hardware, or by combinations thereof.

Program or code segments making up the various embodiments may be stored in a computer readable medium or transmitted by a computer data signal embodied in a carrier wave, or a signal modulated by a carrier, over a transmission medium. For instance, a computer program product including a program code stored in a computer readable medium (e.g., a non-transitory computer readable medium) may form various embodiments. The “computer readable medium” may include any medium that can store or transfer information. Examples of the computer readable medium include an electronic circuit, a semiconductor memory device, a read only memory (“ROM”), a flash memory, an erasable ROM (“EROM”), a floppy diskette, a compact disk (“CD”)-ROM, an optical disk, a hard disk, a fiber optic medium, a radio frequency (“RF”) link, and the like. The computer data signal may include any signal that can propagate over a transmission medium such as electronic communication network communication channels, optical fibers, air, electromagnetic links, RF links, and the like. The code segments may be downloaded via computer networks such as the Internet, Intranet, and the like.

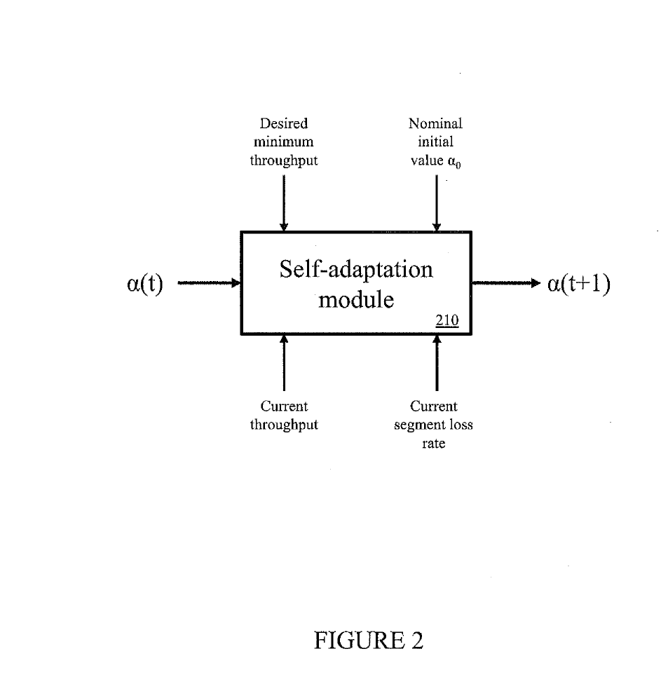

Turning now to FIG. 2, illustrated is a block drawing of an embodiment of a self-adaptation module 210 performing a self-adaptation process for updating a value of a prioritization parameter α(t). The self-adaptation process employs a nominal initial value α₀ for the prioritization parameter α(t). At subsequent time steps, the self-adaptation process compares a desired minimum throughput for data produced by a source such as a TCP file server with a present throughput and examines a present segment loss rate. If the present throughput is less than the desired minimum throughput and/or the present segment loss rate is higher than an expected segment loss rate, then the self-adaptation process increases the present value of the prioritization parameter α(t) to produce a new value of the prioritization parameter α(t+1) for the next round-trip time.

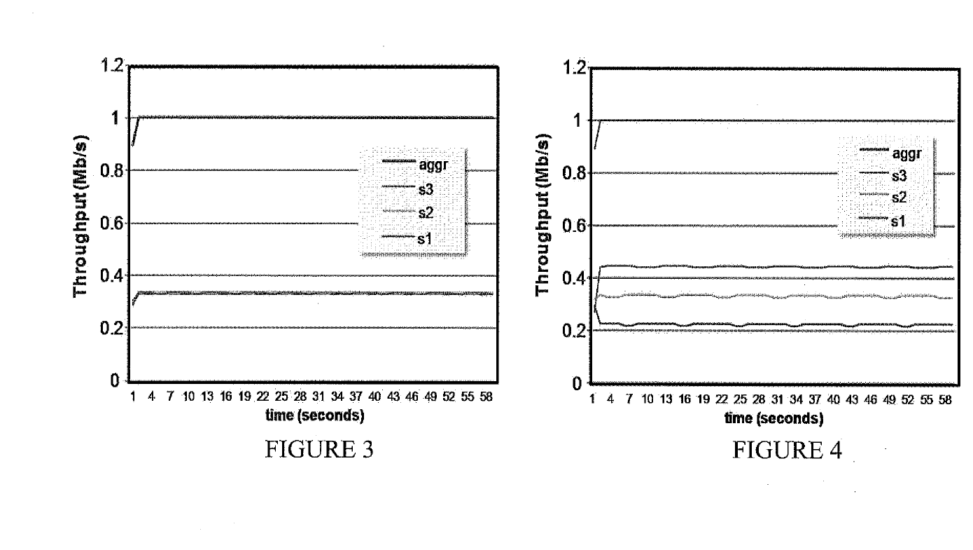

Turning now to FIGS. 3 and 4, illustrated are graphical representations of exemplary simulation results demonstrating throughputs from sources s₁, s₂, s₃ (such as TCP file servers illustrated in FIG. 1) in a network. In FIG. 3, the value of the prioritization parameter α is the same for all three sources s₁, s₂, s₃ (i.e., the prioritization parameter α is the same for all information flows). In FIG. 4, the value of the prioritization parameter a is variable by source such as for source s₁, α₁=1, for source s₂, α₂=2, and for source s₃, α₃=3. In this example, the corresponding receivers r₁, r₂, r₃ (such as user equipment illustrated in FIG. 1) are attempting simultaneous TCP Vegas-based file downloads from the respective sources s₁, s₂, s₃, and share a one Megabit/second (“Mb/s”) bottleneck bandwidth. The sources s₁, s₂, s₃ and associated file downloads each have different priorities, with receiver r₁ being the lowest and receiver r₃ being the highest (i.e., a higher prioritization parameter α implies higher priority). All three information flows pass through a common network bottleneck with limited bandwidth (a bandwidth-limited hop). By the end of their slow-start phase (about five round-trip times), all information flows reach an equilibrium point reflecting different values of the prioritization parameter α. In a conventional TCP Vegas operation (i.e., with all values of the prioritization parameter α equal), each of the three information flows receives approximately one-third of the bottleneck bandwidth, and the three information flows' throughputs would be roughly the same.

Employing the mechanism introduced herein for prioritizing bandwidth among the three sources s₁, s₂, s₃, the three information flows utilize different prioritization parameter a values and achieve correspondingly different throughputs, with the information flow between the highest-priority source/receiver s₃/r₃ receiving the greatest share of the bottleneck bandwidth. FIG. 4 illustrates the simulation results when the information flows are prioritized unequally, with α₁=1, α₂=2, and α₃=3. Comparing the two graphs, it can be seen that the process introduced herein for managing a shared bottleneck/limited bandwidth allows prioritized bandwidth allocation instead of treating all information flows the same without prioritization capability.

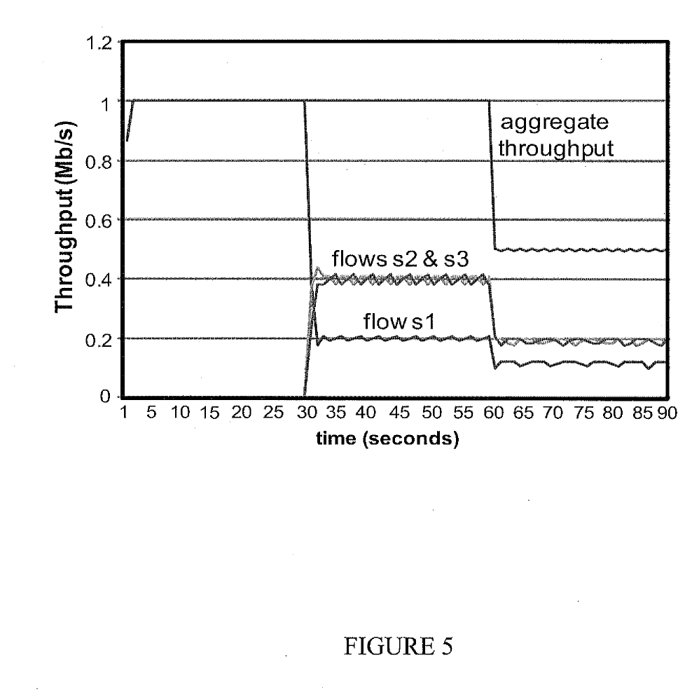

Turning now to FIG. 5, illustrated is another graphical representation of an exemplary simulation result demonstrating throughputs from sources s₁, s₂, s₃ (such as TCP file servers illustrated in FIG. 1) in a network. The graphical representation illustrates a response of the network with prioritization parameters α₂=α₃=3 (for sources s₂, s₃) and α₁=2 (for source s₁) before and after reduction in path capacity at time t=60. The higher-priority information flows from sources s₂, s₃ start 30 seconds into the run. At that time, the lower-priority information flow from source s₁ yields to the information flow from sources s₂, s₃, which both achieve higher throughput. The available link bandwidth is then cut in half at 60 seconds, an event that might be a result of, for instance, a distributed denial-of-service (“DDoS”) attack, wireless path impairment, or a switch configuration error (either inadvertent or deliberate). The rapid response of all information flows to this event as illustrated in FIG. 5 maintains the information flows' proportional throughputs.

The TCP algorithm as set forth herein provides a prioritization capability that is missing from a conventional TCP, which treats all information flows equally. However, the process of prioritizing bandwidth by adjusting the value of the prioritization parameter α may still be improved for a given information flow's throughput requirements. Consider the case of N information flows sharing a bottleneck of bandwidth B, with information flow 1 having a priority “m” times as high as the other N−1 information flows. The proportional fairness property dictates that in equilibrium, information flow 1 would get in times as much as any other information flows for a bottleneck bandwidth B (i.e., m·B/(N+m−1), with the other information flows each getting B/(N+m−1) each. For large N, the higher-priority information flow's share may still be too low to achieve adequate mission utility for the associated application, depending on how many other information flows are sharing the bottleneck.

To provide a further level of information flow prioritization, the value of the prioritization parameter a is made dynamically adaptive within and during information flows as opposed to holding each information flow's prioritization parameter α value constant for the whole information flow duration. This approach is referred to herein as self-adaptive bargaining. In an embodiment, information flow throughput is monitored and the value of the prioritization parameter α(t) (wherein α(t) represents the prioritization parameter α as a function of time) is increased up to a maximum value αₘₐₓ if the throughput remains below an application-specific or user-specific threshold provided by a planning interface. Increasing the value of the prioritization parameter α(t) for a particular host seizes a larger portion of the bottleneck bandwidth than interfering information flows with lower prioritization parameter α(t) values, by the proportional fairness property: Each host sharing a common bottleneck now receives a portion of the bottleneck bandwidth proportional to its prioritization parameter. In practice, this process increases the probability of achieving a desired threshold throughput. Nonetheless, it cannot guarantee achieving a desired threshold throughput. Moreover, this process will be applied to the selected applications and user equipment as specified by a planning interface. If all information flows were to utilize this technique, less net benefit would accrue for any information flow because each information flow would potentially increase its prioritization parameter α(t) up to its maximum value αₘₐₓ.

The adaptation process for the value of the prioritization parameter α(t) accurately infers the steady-state throughput that the initial prioritization parameter α value will produce following the end of the initial TCP slow-start phase. This process can compute a rolling-time average of a source's transmission rate x_{avg}(t) over a period of time extending over R round-trip times or L TCP segment losses, whichever is shortest. At the end of each averaging period, the process compares the source's transmission rate x_{avg}(t) with a desired throughput threshold xₜₕᵣₑₛₕ and increases the prioritization parameter α(t) if the source's transmission rate x_{avg}(t) is below the threshold, such that the prioritization parameter α(t) asymptotically approaches the prioritization parameter maximum value αₘₐₓ.

If the initial value of the prioritization parameter α(t) is α₀, an example of such a process is:
if (in initial slow start∥no_losses)
   then α(t)=α₀;
else if (x_{avg}(t)<xₜₕᵣₑₛₕ),
   then α(t+1)=(α(t)+αₘₐₓ)/2,
      wherein no_losses indicates that the steady-state connection experienced no congestion over a period of R round-trip times. If x_{avg}(t)<xₜₕᵣₑₛₕ, (i.e., if the source's rolling-time average transmission rate x_{avg}(t) is less than a desired minimum throughput), then a difference between the present value of the prioritization parameter α(t) and the maximum value αₘₐₓ thereof is split so that the value of the prioritization parameter α(t) approaches the maximum value αₘₐₓ with each iteration.

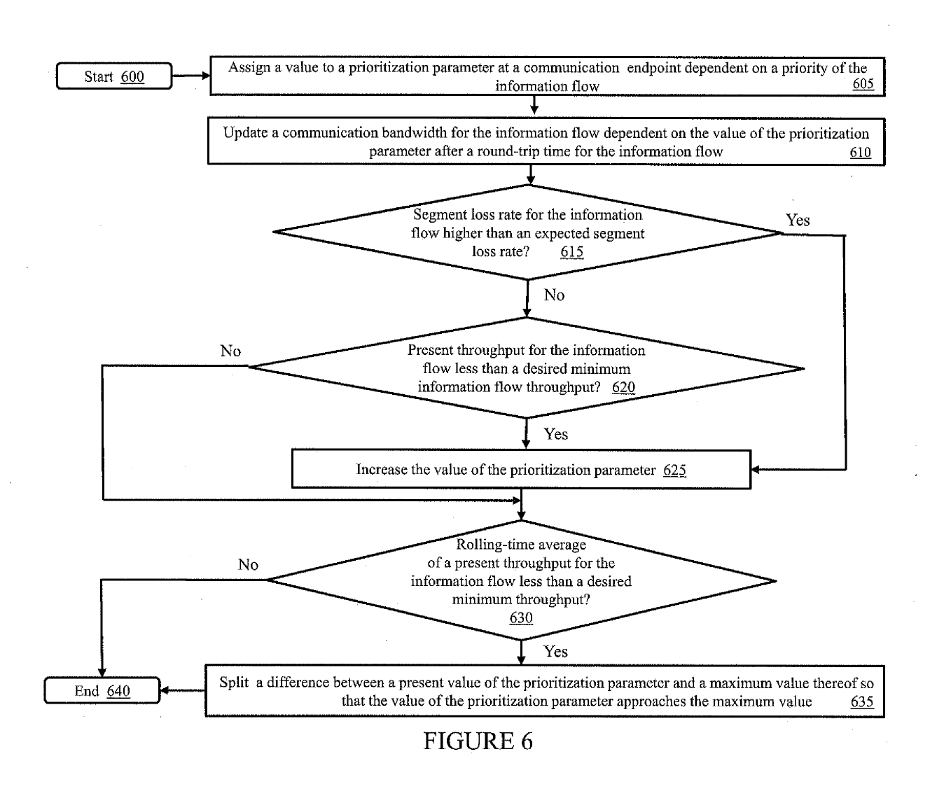

Turning now to FIG. 6, illustrated is a flow diagram of an embodiment of a method of prioritizing bandwidth allocations for an information flow in a network such as an IP network. The method determines a value of a prioritization parameter for a TCP internetworking control component as in an IP network. The method begins in a start step or module 600. At a step or module 605, a value is assigned to a prioritization parameter (e.g., a prioritization parameter α) at an endpoint communication device (e.g., user equipment) dependent on a priority of the information flow. At a step or module 610, a communication bandwidth for the information flow is updated dependent on the value of the prioritization parameter after a round-trip time for the information flow. In an embodiment, the communication bandwidth is determined by the congestion window produced by a TCP internetworking control process. In an embodiment, the prioritization parameter is updated after a round-trip time.

At a step or module 615, a segment loss rate for the information flow is examined to see if the segment loss rate is higher than an expected segment loss rate. If the segment loss rate is not higher, the method proceeds to a step or module 620. Otherwise, the method proceeds to a step or module 625. In the step or module 620, the present throughput for the information flow is examined to see if the present throughput is less than a desired minimum information flow throughput. If the present throughput for the information flow is less than the desired minimum information flow throughput, the method proceeds to a step or module 625. Otherwise, the method proceeds to a step or module 630.

In the step or module 625, the value of the prioritization parameter is increased. The maximum value can be an application-specific, information flow-specific, or user-specific threshold provided by a planning interface. In the step or module 630, a rolling-time average of the present throughput for the information flow is examined to see if the rolling-time average of the present throughput is less than a desired minimum throughput. If it is not, the method ends at a step or module 640. Otherwise, in a step or module 635, a difference between a present value of the prioritization parameter and a maximum value thereof is split (e.g., in half), so that the value of the prioritization parameter approaches the maximum value over a sequence of round-trip times. In an embodiment, the value of the prioritization parameter is increased to asymptotically approach the maximum value thereof. The method ends at the step or module 640.

Thus, a process has been introduced for prioritizing allocation at, for instance, an endpoint communication device of a limited bandwidth among a plurality of simultaneously competing information flows. The process is fully distributed and scalable, and is more reliable than approaches that rely on centralized bandwidth brokers and related mechanisms. Higher reliability follows from the elimination of connectivity with a broker to receive prioritized allocations. Such connectivity with a broker may be difficult to maintain in wireless networks or in networks that are under attack. Special signaling to communicate prioritizations or to allocate bandwidth is not required, and allocations and prioritizations are implicit in the actions of the TCP stacks at the sources or the endpoint communication devices. The process is fully compatible with all red/black encryption boundaries, unlike techniques that utilize special signaling protocols, such as RSVP and TIA 1039.

The process differs from DiffSery in that pre-defined allocations of bandwidth or bandwidth partitioning among service classes are not required. The process is more secure than DiffSery because it does not expose prioritization information within information flows. Special capabilities within IP routers or other network infrastructure are not required, unlike RSVP and TIA1039. The methods and procedures can be incorporated into software operating systems on endpoint communication devices (e.g., user equipment such as computers, smart phones, etc.).

An apparatus, system and method are introduced for prioritizing allocation of communication bandwidth in a network. In one embodiment, the apparatus (e.g., embodied in a router) includes memory including computer program code configured to, with a processor, cause the apparatus to assign a value to a prioritization parameter at an endpoint communication device dependent on a priority of an information flow in a network, and update a communication bandwidth (e.g., a congestion window produced by a transmission control protocol (“TCP”) internetworking control process) for the information flow dependent on the value of the prioritization parameter after a round-trip time for the information flow. The communication bandwidth may be a bandwidth-limited hop shared by a plurality of information flows. The value of the prioritization parameter may be updated after the round-trip time.

The apparatus is also configured to increase the value of the prioritization parameter in response to a segment loss rate for the information flow higher than an expected segment loss rate, and/or increase the value of the prioritization parameter if a present throughput for the information flow is less than a desired minimum throughput for the information flow. The value of the prioritization parameter is increased to asymptotically approach a maximum value thereof The maximum value includes an information flow-specific or user-specific threshold provided by a planning interface. The apparatus is also configured to split a difference between a present value of the prioritization parameter and a maximum value thereof if a rolling-time average of a present throughput for the information flow is less than a desired minimum throughput so that the value of the prioritization parameter approaches the maximum value.

As described above, the exemplary embodiment provides both a method and corresponding apparatus consisting of various modules providing functionality for performing the steps of the method. The modules may be implemented as hardware (embodied in one or more chips including an integrated circuit such as an application specific integrated circuit), or may be implemented as software or firmware for execution by a computer processor. In particular, in the case of firmware or software, the exemplary embodiment can be provided as a computer program product including a computer readable storage structure embodying computer program code (i.e., software or firmware) thereon for execution by the computer processor.

Although the embodiments and its advantages have been described in detail, it should be understood that various changes, substitutions, and alterations can be made herein without departing from the spirit and scope thereof as defined by the appended claims. For example, many of the features and functions discussed above can be implemented in software, hardware, or firmware, or a combination thereof. Also, many of the features, functions, and steps of operating the same may be reordered, omitted, added, etc., and still fall within the broad scope of the various embodiments.

Moreover, the scope of the various embodiments is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized as well. Accordingly, the appended claims are intended to include within their scope such processes, machines, manufacture, compositions of matter, means, methods, or steps.

What is claimed is:

1. A method of prioritizing bandwidth allocations for an information flow in a network, comprising:
assigning a value to a prioritization parameter at an endpoint communication device dependent on a priority of said information flow; and
updating a communication bandwidth for said information flow dependent on said value of said prioritization parameter after a round-trip time for said information flow.

2. The method as recited in claim 1 wherein said communication bandwidth is a congestion window produced by a transmission control protocol (“TCP”) internetworking control process.

3. The method as recited in claim 1 wherein said communication bandwidth is bandwidth-limited hop shared by a plurality of information flows.

4. The method as recited in claim 1 wherein said value of said prioritization parameter is updated after said round-trip time.

5. The method as recited in claim 1 further comprising increasing said value of said prioritization parameter in response to a segment loss rate for said information flow higher than an expected segment loss rate.

6. The method as recited in claim 1 further comprising increasing said value of said prioritization parameter if a present throughput for said information flow is less than a desired minimum throughput for said information flow.

7. The method as recited in claim 1 wherein said value of said prioritization parameter is increased to asymptotically approach a maximum value thereof in accordance with an information flow-specific or user-specific threshold.

8. The method as recited in claim 1 further comprising splitting a difference between a present value of said prioritization parameter and a maximum value thereof if a rolling-time average of a present throughput for said information flow is less than a desired minimum throughput so that said value of said prioritization parameter approaches said maximum value.

9. An apparatus operable to prioritize bandwidth allocations for an information flow in a network, comprising:
a processor; and
memory including computer program code, said memory and said computer program code configured to, with said processor, cause said apparatus to perform at least the following:
assign a value to a prioritization parameter at an endpoint communication device dependent on a priority of said information flow, and
update a communication bandwidth for said information flow dependent on said value of said prioritization parameter after a round-trip time for said information flow.

10. The apparatus as recited in claim 9 wherein said communication bandwidth is a congestion window produced by a transmission control protocol (“TCP”) internetworking control process.

11. The apparatus as recited in claim 9 wherein said communication bandwidth is bandwidth-limited hop shared by a plurality of information flows.

12. The apparatus as recited in claim 9 wherein said memory and said computer program code are further configured to, with said processor, cause said apparatus to update said value of said prioritization parameter is after said round-trip time.

13. The apparatus as recited in claim 9 wherein said memory and said computer program code are further configured to, with said processor, cause said apparatus to increase said value of said prioritization parameter in response to a segment loss rate for said information flow higher than an expected segment loss rate.

14. The apparatus as recited in claim 9 wherein said memory and said computer program code are further configured to, with said processor, cause said apparatus to increase said value of said prioritization parameter if a present throughput for said information flow is less than a desired minimum throughput for said information flow.

15. The apparatus as recited in claim 9 wherein said value of said prioritization parameter is increased to asymptotically approach a maximum value thereof

16. The apparatus as recited in claim 9 wherein said memory and said computer program code are further configured to, with said processor, cause said apparatus to split a difference between a present value of said prioritization parameter and a maximum value thereof if a rolling-time average of a present throughput for said information flow is less than a desired minimum throughput so that said value of said prioritization parameter approaches said maximum value.

17. A computer program product comprising a program code stored in a computer readable medium configured to:
assign a value to a prioritization parameter at an endpoint communication device dependent on a priority of an information flow in a network, and
update a communication bandwidth for said information flow dependent on said value of said prioritization parameter after a round-trip time for said information flow.

18. The computer program product as recited in claim 17 wherein said program code stored in said computer readable medium is further configured to increase said value of said prioritization parameter in response to a segment loss rate for said information flow higher than an expected segment loss rate.

19. The computer program product as recited in claim 17 wherein said program code stored in said computer readable medium is further configured to increase said value of said prioritization parameter if a present throughput for said information flow is less than a desired minimum throughput for said information flow.

20. The computer program product as recited in claim 17 wherein said program code stored in said computer readable medium is further configured split a difference between a present value of said prioritization parameter and a maximum value thereof if a rolling-time average of a present throughput for said information flow is less than a desired minimum throughput so that said value of said prioritization parameter approaches said maximum value.
